(19) United States
(12) Patent Application Publication
(10) Pub. No.: US 2024/0269989 A1
(43) Pub. Date: Aug. 15, 2024

(54) INK RESERVOIR FOR PRINTHEAD, INK SUPPLY SYSTEM FOR PRINTER AND PRINTER

(71) Applicant: Procolored Technology Inc, Pico Rivera (CA)

(72) Inventor: Jiangyu WU, Shenzhen (CN)

(21) Appl. No.: 18/643,770

(22) Filed: Apr. 23, 2024

(30) Foreign Application Priority Data
Feb. 16, 2024 (CN) 202420291906.2

(51) Int. Cl. B41J 2/175

(52) U.S. Cl. CPC B41J 2/17596; B41J 2/17553; B41J 2/17563; B41P 2251/11

(57) ABSTRACT

An ink reservoir for a printhead, an ink supply system and a printer are provided. The ink reservoir includes a main body including a first cavity, a second cavity, a first pipeline, a first inlet communicated with the first cavity, a first outlet communicated with the second cavity, a valve arranged in the first pipeline and a first film. The first cavity is communicated with the second cavity through the first pipeline. The first outlet is configured for mounting the printhead. The valve includes a piston and an elastic component configured to apply force to the piston in a direction from the first side toward the second side to allow a first end of the piston to block the first pipeline. The first film is provided at the second side for sealing the second cavity, and is abutted by a second end of the piston.

### CROSS-REFERENCE TO RELATED APPLICATIONS

This application claims the benefit of priority from Chinese Patent Application No. 202420291906.2, filed on Feb. 16, 2024. The content of the aforementioned application, including any intervening amendments made thereto, is incorporated herein by reference in its entirety.

### TECHNICAL FIELD

This application relates to printers, and more particularly to an ink reservoir for a printhead, an ink supply system for a printer and a printer.

### BACKGROUND

For the existing ultraviolet (UV) printers, the ink is supplied from the ink cartridge to the printhead through siphonage. Due to the long pipe between the printhead and ink cartridge, the suction force may be insufficient sometimes, resulting in insufficient ink supply to the printhead. In addition, in the case that there is not enough ink in the pipeline between the printhead and the ink cartridge, the printhead may also experience insufficient ink supply, thus affecting the printing quality. Moreover, the direct connection between the printhead and the pipeline may also lead to unstable ink supply, thus affecting the printing quality.

### SUMMARY

An object of the disclosure is to provide an ink reservoir for a printhead, which can improve the stability of ink supply to the printhead, so as to solve at least one of the problems in the prior art to a certain extent. In addition, an ink supply system and a printer including the above ink reservoir are also provided.

In order to achieve the above object, the following technical solutions are adopted.

In a first aspect, this application provides an ink reservoir for a printhead, comprising:
a main body;
a first valve; and
a film;
wherein the main body comprises a first cavity, a second cavity, a first pipeline, a first inlet and a first outlet; the first cavity is located at a first side of the main body; the second cavity is located at a second side of the main body opposite to the first side of the main body; the first cavity is communicated with the second cavity through the first pipeline; the first inlet is communicated with the first cavity; the first outlet is communicated with the second cavity, and is configured for mounting the printhead; the first valve is arranged in the first pipeline, and comprises a piston and an elastic component; and the elastic component is configured to apply a first force to the piston in a direction from the first side of the main body toward the second side of the main body, such that the first pipeline is blocked by a first end of the piston; and the film is provided at the second side for sealing the second cavity; a second end of the piston abuts against the film; and the film is configured to apply a second force to the piston in a direction from the second side of the main body toward the first side of the main body as a pressure in the second cavity decreases, so as to open the first pipeline.

The ink reservoir can improve the stability of ink supply to the printhead.

In some embodiments, a first filter is provided in the first cavity.

In some embodiments, the main body further comprises a barrier wall provided between the first cavity and the first pipeline; and the barrier wall is configured to reduce a cross-sectional area of a communicating opening between the first cavity and the first pipeline.

In some embodiments, the first pipeline comprises a through channel and an extension channel; the through channel is configured to penetrate through the main body along the direction from the first side of the main body toward the second side of the main body; and a first end of the extension channel is communicated with the communicating opening between the first cavity and the first pipeline, and a second end of the extension channel is communicated with the through channel.

In some embodiments, the first valve is arranged in the through channel; the elastic component abuts against the first end of the piston at the first side of the main body; and the second end of the piston passes through the through channel to enter the second cavity and abut against the film.

In some embodiments, a reinforcing portion is provided at a middle of the film, and the second end of the piston abuts against the reinforcing portion.

In some embodiments, ink reservoir further comprises a second valve; wherein the second valve is a one-way valve, and is arranged in the first outlet; and the second valve is configured to block the second cavity in a state that the first outlet is not connected to the printhead.

In a second aspect, this application provides an ink supply system for a printer, comprising:
an ink cartridge;
a pump;
the above ink reservoir; and
a printhead;
wherein the ink cartridge comprises a second inlet and a second outlet; the pump comprises a third inlet and a third outlet; the third inlet is communicated with the second outlet through a second pipeline; and the third outlet is communicated with the second inlet through a third pipeline; the first inlet is connected in parallel to the second pipeline or the third pipeline through a fourth pipeline; and the printhead is removably mounted to the first outlet.

The ink supply system can improve the stability of the ink supply to the printhead.

In some embodiments, the pump is a diaphragm pump.

In a third aspect, this application provides a printer, comprising:
a manipulator; and
the above ink supply system;
wherein the manipulator comprises an end portion; and the pump, the ink reservoir and the printhead are mounted to the end portion.

The printer can improve the stability of the ink supply to the printhead.

### BRIEF DESCRIPTION OF THE DRAWINGS

FIG. 1 is an exploded view of an ink reservoir for a printer in accordance with an embodiment of the present disclosure;

FIG. 2 is a cross-sectional view of the ink reservoir in accordance with an embodiment of the present disclosure in a first state;

FIG. 3 is a cross-sectional view of the ink reservoir in accordance with an embodiment of the present disclosure in a second state;

FIG. 4 is a front perspective view of a main body of the ink reservoir in accordance with an embodiment of the present disclosure;

FIG. 5 is a rear perspective view of the main body in accordance with an embodiment of the present disclosure;

FIG. 6 is a front view of the main body in accordance with an embodiment of the present disclosure;

FIG. 7 is a schematic diagram of an ink supply system having the ink reservoir in accordance with an embodiment of the present disclosure; and

FIG. 8 is a schematic diagram of a printer having the ink supply system in accordance with an embodiment of the present disclosure.

### DETAILED DESCRIPTION OF EMBODIMENTS

The embodiments of the present disclosure are described in detail below, and are shown schematically in the accompanying drawings, where the same or similar reference numerals throughout represent the same or similar elements or elements with the same or similar functions. The embodiments described below with reference to the drawings are merely illustrative for explaining the present disclosure, and are not intended to limit the scope of the present disclosure.

In the description of the embodiments, it should be understood that orientation or positional relationships related to orientation descriptions, such as up, down, front, rear, left and right, are based on orientation or position relationships shown in the drawings, which are merely intended to facilitate the description of the embodiments and simplify the description, and are not intended to indicate or imply that a device or element referred to must have a specific orientation, be constructed and operated in a specific orientation. Therefore, these orientation or positional relationships cannot be construed as limiting the present disclosure.

As used herein, “several” means one or more; “a plurality of” means two or more; “greater than”, “less than”, “exceeding”, etc. are understood to exclude the mentioned number itself; and “above”, “below”, “within”, etc. are understood to include the mentioned number itself. Terms such as “first” and “second” are only used to distinguish technical features, and are not intended to indicate or imply the relative importance or implicitly indicate the number of indicated technical features or implicitly indicate the sequence of indicated technical features.

In the description of the embodiments, unless otherwise explicitly limited, terms such as “arrangement”, “mounting” and “connection” should be interpreted in a broad sense. Those skilled in the art can reasonably determine the specific meaning of the above terms in the embodiments based on the specific technical solutions.

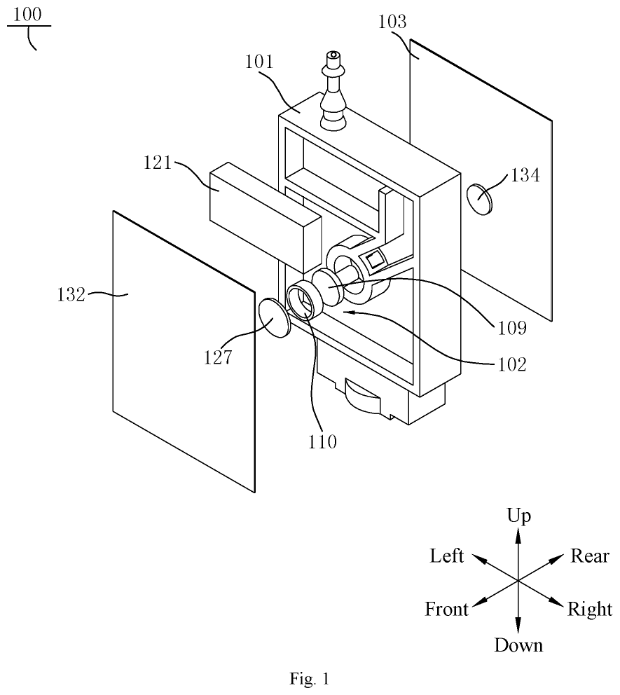

As shown in FIGS. 1-8, an ink reservoir 100 for a printhead is provided. The ink reservoir 100 is configured to be mounted between a printhead 201 and a main ink supply path 202 of a printer 300. In some embodiments, the printhead 201 is directly mounted to an outlet end of the ink reservoir 100 (for the convenience of distinction, the outlet end of the ink reservoir 100 will be referred to as the “first outlet 108” below).

As shown in FIGS. 1-6, the ink reservoir 100 includes a main body 101, a first valve 102 and a first film 103. The main body 101 includes a first cavity 104, a second cavity 105, a first pipeline 106, a first inlet 107 and the first outlet 108. The first cavity 104 is located at a first side (for the convenience of explanation, in the following description, it is also referred to as the “front side”) of the main body 101. The second cavity 105 is located at a second side (for the convenience of explanation, in the following description, it is also referred to as the “rear side”) of the main body 101 opposite to the first side of the main body 101. The first cavity 104 is communicated with the second cavity 105 through the first pipeline 106. The first inlet 107 is communicated with the first cavity 104, and is configured for connecting the ink reservoir 100 to an ink supply system 200. The first outlet 108 is communicated with the second cavity 105, and is configured for mounting the printhead 201. The first valve 102 is arranged in the first pipeline 106, and includes a piston 109 and an elastic component 110. The elastic component 110 is configured to apply a first force to the piston 109 in a direction from the first side of the main body 101 to the second side of the main body 101 (i.e., a direction from the front side to the rear side), such that the first pipeline 106 is blocked by a first end (a front end in the drawings, i.e., a large diameter end) of the piston 109. The first film 103 is provided at the second side for sealing the second cavity 105. A second end (a rear end in the drawings, i.e., a small diameter end) of the piston 109 abuts against the first film 103. The first film 103 is configured to apply a second force to the piston 109 in a direction from the second side of the main body 101 toward the first side of the main body 101 as a pressure in the second cavity 105 decreases, so as to open the first pipeline 106.

The ink reservoir 100 can improve the stability of ink supply to the printhead 201. In some embodiments, the ink reservoir 100 is mounted between the printhead 201 and the main ink supply path 202. In some embodiments, the printhead 201 is directly mounted at an inlet end of the printhead 201, which can separate the printhead 201 from the ink supply system 200 of the printer 300 to a certain extent, and buffer ink from an ink cartridge 203.

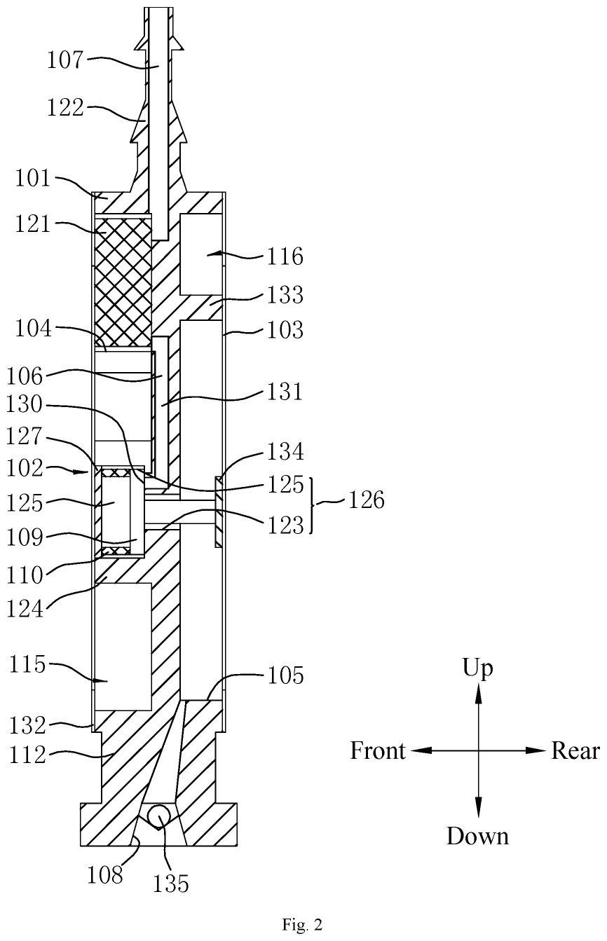

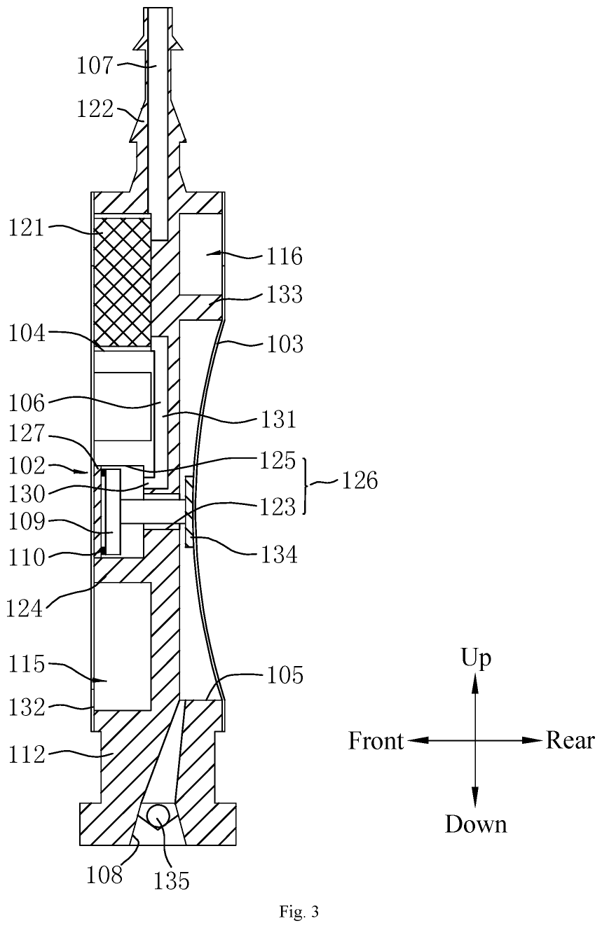

FIG. 2 is a cross-sectional view of the ink reservoir 100 in a first state that the first cavity 104 and the second cavity 105 are blocked by the first valve 102. FIG. 3 is a cross-sectional view of the ink reservoir 100 in a second state that the first valve 102 is pressed by the first film 103 to open. In addition, it should be noted that, for the convenience of illustration, the cross-sectional views of FIGS. 2-3 do not strictly correspond to a structure of the ink reservoir 100 in FIG. 1. As shown in FIGS. 2-3, specifically, the first cavity 104 and the second cavity 105 are provided in the main body 101. The first valve 102 is configured to control the communication or blocking between the first cavity 104 and the second cavity 105. After ink from the ink cartridge 203 enters the ink reservoir 100, it is first stored in the first cavity 104. The ink from the second cavity 105 is sucked into the printhead 201 through a siphon effect. Then, since a pressure outside the ink reservoir 100 is greater than a pressure in the second cavity 105, the first film 103 is pressed in a direction from the rear to the front by the air, resulting in a decrease in a volume of the second cavity 105. Simultaneously, the first film 103 overcomes a pressing force from the elastic component 110 and applies a force to the piston 109 in the direction from the rear to the front, such that the piston 109 is pushed open. After the piston 109 is opened, ink stored in the first cavity 104 passes through the first pipeline 106 to enter the second cavity 105, and presses the first film 103 in the direction from the front to the rear, such that the first film 103 is expanded toward an outside of the ink reservoir 100. Simultaneously, a pressing force applied by the first film 103 to the piston 109 is gradually weakened. Finally, the piston 109 blocks the first pipeline 106 again, thereby blocking the first cavity 104 and the second cavity 105.

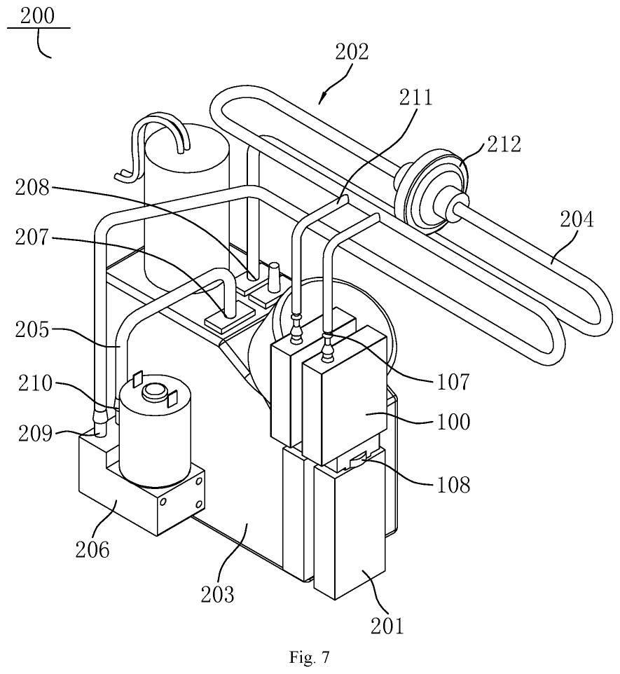

Therefore, the ink reservoir 100 is arranged between the printhead 201 and the main ink supply path 202 (auxiliary reference to FIG. 7) of the printer 300, such that the influence of the fluctuation of the ink in the main ink supply path 202 on the printhead 201 can be suppressed, thus stabilizing ink supply to the printhead 201 to a certain extent, and improving the stability of ink supply to the printhead 201. In addition, to-be-siphoned ink is stored in the second cavity 105, such that the ink stored in the printhead 201 can be reduced, thereby reducing the ink settling in the printhead 201 to prevent the printhead 201 from being clogged.

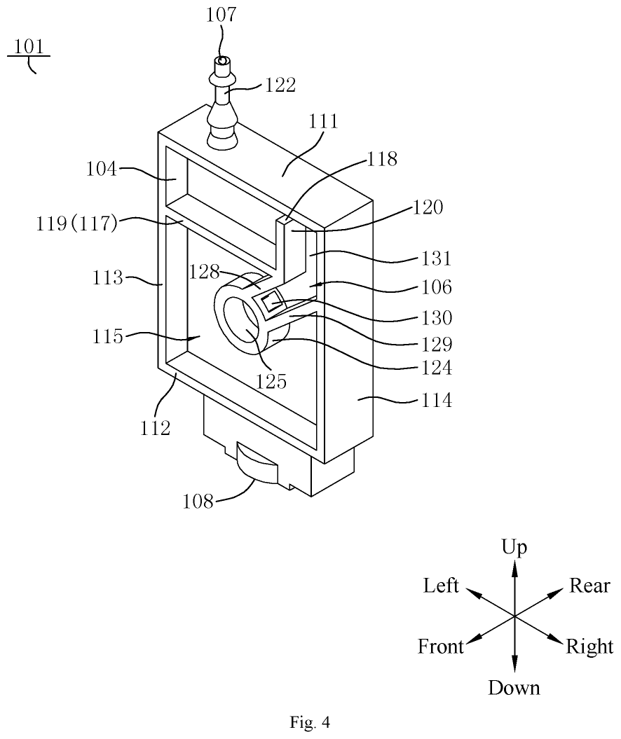

Referring to FIGS. 4-6, and with auxiliary reference to FIGS. 2-3, the main body 101 can be located by injection molding or three-dimensional (3D) printing. The main body 101 is in a rectangular shape as a whole. The main body 101 includes an upper wall 111, a lower wall 112, a left wall 113 and a right wall 114 surrounding its periphery. A front side of the main body 101 is consecutively surrounded by the upper wall 111, the lower wall 112, the left wall 113 and the right wall 114, thereby forming a first recess 115 at a middle portion of the front side of the main body 101. The first recess 115 can be entirely or partially configured as the first cavity 104. A rear side of the main body 101 is consecutively surrounded by the upper wall 111, the lower wall 112, the left wall 113 and the right wall 114, thereby forming a second recess 116 at a middle portion of the rear side of the main body 101. The second recess 116 can be entirely or partially configured as the second cavity 105.

In an embodiment, the first recess 115 can be partially configured as the first cavity 104. Specifically, the main body 101 includes a barrier wall 117 provided between the first cavity 104 and the first pipeline 106. The barrier wall 117 is configured to reduce a cross-sectional area of a first communicating opening 118 between the first cavity 104 and the first pipeline 106. The barrier wall 117 includes a first extension portion 119 and a second extension portion 120. The first extension portion 119 is arranged at an upper position in an up-down direction of the first recess 115. A first end of the first extension portion 119 is connected to the left wall 113. A second end of the first extension portion 119 extends in a right direction, and is connected to a first end of the second extension portion 120. A second end of the second extension portion 120 extends in an upward direction, and is opposite to the upper wall 111 with a gap (i.e., the first communicating opening 118) therebetween. A left portion of the upper wall 111, an upper portion of the left wall 113, the first extension portion 119 and the second extension portion 120 jointly define the first cavity 104.

In addition, the first cavity 104 includes a first filter 121. The first filter 121 is not particularly limited as long as it can filter tiny sediments in the ink, such as a filter screen and a filter cotton.

An upper portion of the main body 101 is provided with a male head 122 extending in an upward direction from an outside of the upper wall 111. The male head 122 is configured to insert the ink reservoir 100 into the main ink supply path 202. In an embodiment, the male head 122 is configured to connect the ink reservoir 100 in parallel to a second pipeline 204 or a third pipeline 205 of the ink supply system 200.

The first inlet 107 passes through the male head 122 in an up-down direction and extends to the first cavity 104.

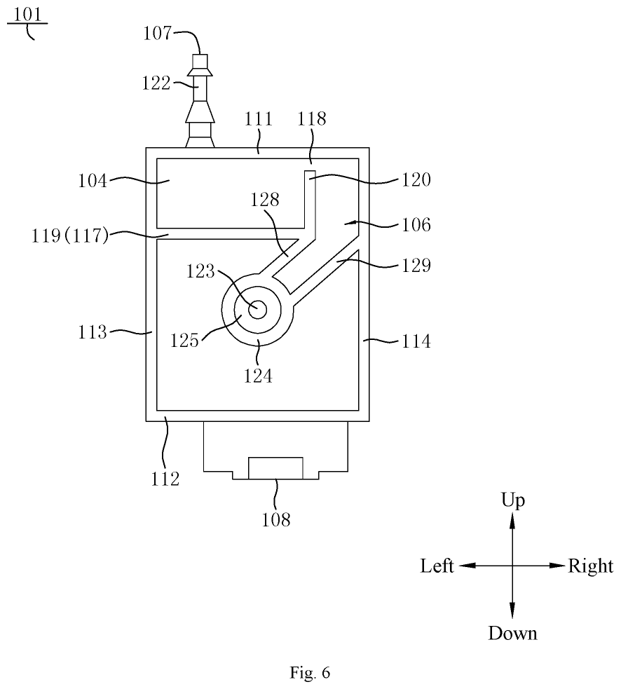

Referring to FIGS. 4 and 6, the first recess 115 is provided with a through hole 123 at a lower position in the up-down direction and centered in a left-right direction. The through hole 123 penetrates the main body 101 along the direction from the first side of the main body 101 toward the second side of the main body 101 (i.e., a direction from the front side to the rear side), and is configured to allow the first cavity 104 to be communicated with the second cavity 105. The first recess 115 is provided with a first annular wall 124 at a position coaxial with the through hole 123. A height of the first annular wall 124 is slightly lower than that of the upper wall 111. The first annular wall 124 is provided with a receiving hole 125 coaxially communicated with the through hole 123. The receiving hole 125 and the through hole 123 jointly define a through channel 126 of the first pipeline 106. In addition, an opening at a front side of the first annular wall 124 is blocked in a way which is not particularly limited. In some embodiments, the opening at the front side of the annular wall 124 can be blocked in a known way such as ultrasonic welding or hot melting with a plug 127.

The first recess 115 is provided with a first guide wall 128 and a second guide wall 129 at a position between the first extension portion 119 and the first annular wall 124 in the up-down direction. A first end of the first guide wall 128 is connected to the first annular wall 124. A second end of the first guide wall 128 is connected to a right end of the first extension portion 119. The second guide wall 129 is spaced apart and substantially parallel to the first guide wall 128. Furthermore, a first end of the second guide wall 129 is connected to the first annular wall 124, and a second end of the second guide wall 129 is connected to the right wall 114. In addition, the first annular wall 124 is provided with a second communicating opening 130 at a position sandwiched between the first end of the first guide wall 128 and the first end of the second guide wall 129. Therefore, the upper wall 111, the second extension portion 120, the first guide wall 128, an upper portion of the right wall 114 and the second guide wall 129 jointly define an extension channel 131 of the first pipeline 106. A first end of the extension channel 131 is communicated with the first communicating opening 118. A second end of the extension channel 131 is communicated with the through channel 126 via the second communicating opening 130. Specifically, the extension channel 131 extends in the up-down direction from a substantially top position of an upper portion of the first recess 115, and obliquely downward toward a left direction at a roughly upper position in the up-down direction of the first recess 115 and close to the right wall 114.

As shown in FIG. 1, the ink reservoir 100 further includes a second film 132. The first recess 115 is sealed by the second film 132 at the front side of the main body 101. In some embodiments, the second film 132 is sealed to the main body 101 along the upper wall 111, the lower wall 112, the left wall 113 and the right wall 114 of the main body 101, the barrier wall 117, the first guide wall 128 and the second guide wall 129 by a known method such as ultrasonic welding or hot melt bonding.

Referring to FIGS. 2-3, and with auxiliary reference to FIG. 1, the first valve 102 is arranged in the through channel 126. The elastic component 110 and the first end (large diameter end) of the piston 109 are respectively arranged in the receiving hole 125. The elastic component 110 can be a compression spring, a spring piece or a component made of a resin material with high compressibility. A first end of the elastic component 110 abuts against the plug 127 configured for blocking the first annular wall 124. A second end of the elastic component 110 abuts against the first end of the piston 109. The second end (small diameter end) of the piston 109 passes through the through hole 123 to enter the second cavity 105 and abut against the first film 103.

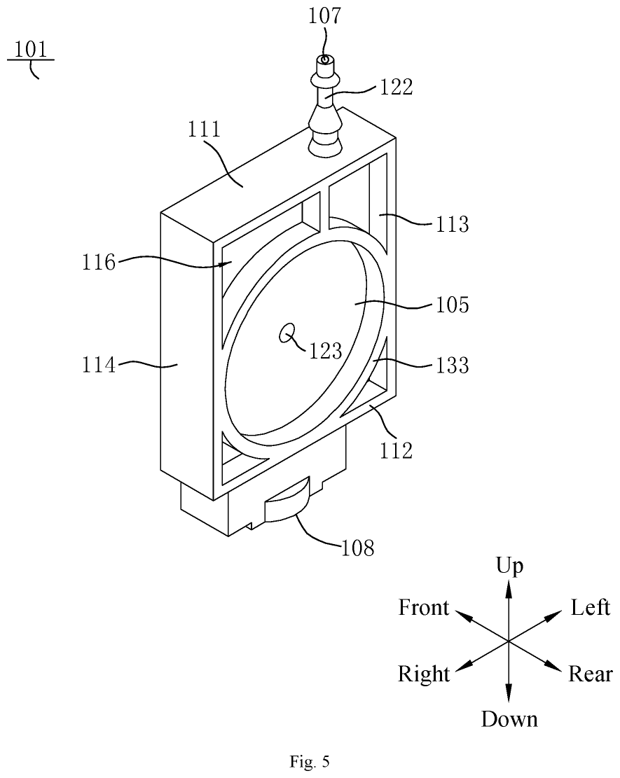

Referring to FIG. 5, as mentioned above, the second recess 116 can be partially configured as the second cavity 105. In an embodiment, the second recess 116 can be provided with a second annular wall 133 at a position coaxial with the through hole 123. The second annular wall 133 is substantially flush with the upper wall 111, the lower wall 112, the left wall 113 and the right wall 114 at the rear side of the main body 101. The second cavity 105 is defined by the second annular wall 133 surrounding the through hole 123. The second annular wall 133 is provided with a left side connected to the left wall 113, a right side connected to the right wall 114, and a lower side connected to the lower wall 112.

The material of the first film 103 is not particularly limited as long as it is deformable and has sufficient strength. In some embodiments, the first film 103 can be a plastic film. The second recess 116 is sealed by the first film 103 at the rear side of the main body 101. In some embodiments, the first film 103 is sealed to the main body 101 along the upper wall 111, the lower wall 112, the left wall 113 and the right wall 114 of the main body 101, and the second annular wall 133 by a known method such as ultrasonic welding or hot melt bonding.

Referring to FIGS. 2-3, and with auxiliary reference to FIG. 1, a reinforcing portion 134 is provided in a middle portion of the first film 103. The first end of the piston 109 abuts against the reinforcing portion 134. There is no particular limitation on a formation method of the reinforcing portion 134. In an embodiment, the reinforcing portion 134 can be a plate-shaped component with a higher hardness than the material of the first film 103 bonded to a side of the first film 103 opposite to the second cavity 105.

Referring to FIGS. 2-3, in a state that the first film 103 is sealed to the main body 101, the small diameter end of the piston 109 is configured to abut against the reinforcing portion 134 and support the middle portion of the first film 103, such that the rear side of the main body 101 is entirely covered with the first film 103 in a substantially planar shape. When an external force is applied to the first film 103 from the outside of the ink reservoir 100, the first film 103 is recessed toward the second cavity 105 approximately based on a center of the second annular wall 133, such that the small diameter end of the piston 109 is pushed by the first film 103 from the rear to the front. When the small diameter end of the piston 109 is pushed, the large diameter end of the piston 109 is driven to move towards the front and squeeze the elastic component 110, such that the second communicating opening 130 provided in the first annular wall 124 is communicated with the through hole 123 via the receiving hole 125. In other words, when the external force is applied to the first film 103 from the outside of the ink reservoir 100, the ink from the first inlet 107 and entering the first cavity 104 through the first filter 121 passes through the first communicating opening 118, the extension channel 131, the second communicating opening 130 and the through channel 126 in sequence to enter the second cavity 105.

The ink entering the second cavity 105 can pass through the first outlet 108 to enter the printhead 201. The first outlet 108 passes through the lower wall 112 from a lower portion of the main body 101 and extends into the second cavity 105. In addition, the ink reservoir 100 further includes a second valve 135 arranged in the first outlet 108. In a state that the first outlet 108 being not connected to the printhead 201, the second cavity 105 is blocked by the second valve 135. The second valve 135 is not particularly limited in structure, which can be a known one-way valve. In am embodiments, the second valve 135 can be mounted into the first outlet 108 by insert molding. Therefore, in a state of the ink reservoir 100 is not connected to the printhead 201, the second cavity 105 is blocked by the second valve 135. When an input end of the printhead 201 is inserted into the first outlet 108, the second valve 135 is pushed open, such that the ink stored in the second cavity 105 can pass through the second valve 135 and the first outlet 108 to enter the printhead 201.

In the ink reservoir 100, the first cavity 104 and the second cavity 105 are provided in the main body 101, and the first valve 102 is configured to control the communication or blocking between the first cavity 104 and the second cavity 105. This can suppress the impact of ink fluctuation in the main ink supply path 202 on the printhead 201, and stabilize the ink supply to the printhead 201 to a certain extent, thereby improving the stability of the ink supply to the printhead 201.

In the ink reservoir 100, the to-be-siphoned ink is stored in the second cavity 105, such that the ink stored in the printhead 201 can be reduced, thereby reducing the ink settling in the printhead 201 to prevent the printhead 201 from being clogged.

In the ink reservoir 100, the barrier wall 117 is provided in the main body 101, and is configured to reduce the cross-sectional area of the first communicating opening 118. This can prevent a large amount of ink from the main ink supply path 202 from being directly poured into the large diameter end of the piston 109, otherwise a pressure at the large diameter end of the piston 109 will increase, making it difficult to open the first valve 102. In addition, the reduction in the cross-sectional area of the first communicating opening 118 can reduce a flow rate of ink entering the second cavity 105 per unit time, thereby suppressing the fluctuation in ink supply to the printhead 201 caused by a large amount of ink from the main ink supply path 202.

In the ink reservoir 100, the first filter 121 is arranged in the first cavity 104, such that the ink can be filtered before entering the second cavity 105, thereby reducing particles or sedimentation in the ink.

In the ink reservoir 100, the extension channel 131 is provided in the first pipeline 106 between the first cavity 104 and the second cavity 105. This can further prevent a large amount of ink from the main ink supply path 202 from being directly poured into the large diameter end of the piston 109, otherwise the pressure at the large diameter end will increase, making it difficult to open the first valve 102. In addition, the flow rate of the ink entering the second cavity 105 per unit time can be further reduced, thereby suppressing the fluctuation in ink supply to the printhead 201 caused by a large amount of ink from the main ink supply path 202.

In the ink reservoir 100, the first valve 102 is arranged in the through channel 126, the elastic component 110 is allowed to abut against the large diameter end of the piston 109 at the first side, and the small diameter end of the piston 109 passes through the through channel 126 to enter the second cavity 105 and abut against the first film 103, such that the first cavity 104 and the second cavity 105 can be easily blocked or opened. Furthermore, such structure can also be easily formed.

In addition, in the ink reservoir 100, the plug 127 is configured to block the first annular wall 124 to form the receiving hole 125, such that the elastic component 110 and the piston 109 can be easily mounted into the receiving hole 125.

In the ink reservoir 100, the second annular wall 133 is provided in the second recess 116, and the first film 103 is sealed to the main body 101 along the upper wall 111, the lower wall 112, the left wall 113 and the right wall 114 of the main body 101 and the second annular wall 133, thereby improving the firmness of sealing the first film 103 to the main body 101 and suppressing ink leakage.

In addition, the reinforcing portion 134 is located at the middle portion of the first film 103, and the small diameter end of the piston 109 abuts against the reinforcing portion 134, such that the strength of the middle portion of the first film 103 can be increased, thereby improving the reliability of the first film 103 pressing the small diameter end of the piston 109, and improving the reliability of the first valve 102 when opening the first cavity 104 and the second cavity 105.

In the ink reservoir 100, the second valve 135 is provided in the first outlet 108, thereby suppressing the leakage of ink from the second cavity 105, and improving the convenience of installation and removal of the printhead 201.

In addition, in the ink reservoir 100, functions such as filtering and buffering are integrated into the main body 101, thereby simplifying the ink supply system 200.

In addition, it should be noted that although the embodiment illustrates that the first recess 115 is sealed by the second film 132, the disclosure is not limited to this. In some embodiments, the first recess 115 can also be directly sealed with a thin plate. In some embodiments, the main body 101 is formed by 3D printing, so it is not necessary to form the first recess 115. In this case, a closed first cavity 104 can be directly provided in the main body 101.

Although the embodiment illustrates that the first filter 121 is arranged in the first cavity 104, the disclosure is not limited to this. In some embodiments, the first filter 121 can be connected to the male head 122 as an independent component. In some embodiments, the ink supply system 200 is originally provided with a filter, and the ink reservoir 100 does not need to be provided with the first filter 121.

Although the embodiment illustrates that the main body 101 is provided with the barrier wall 117 and the extension channel 131, the disclosure is not limited to this. In some embodiments, the main body 101 is not provided with the barrier wall 117, such that the first cavity 104 can be directly connected to the through channel 126.

Although the embodiment illustrates that the reinforcing portion 134 is provided in the middle portion of the first film 103, the disclosure is not limited to this. In some embodiments, an area of the second end of the piston 109 can be increased, thereby increasing a contact area between the first film 103 and the piston 109. In this case, the reinforcing portion 134 can be omitted.

Although the embodiment illustrates that the second valve 135 is provided in the main body 101, the disclosure is not limited to this. In some embodiments, the second valve 135 can be an independent component connected between the ink reservoir 100 and the printhead 201.

As shown in FIG. 7, the ink reservoir 100 can be used in the ink supply system 200. The ink supply system 200 includes the ink cartridge 203, a pump 206, the ink reservoir 100 and the printhead 201. The ink cartridge 203 includes a second inlet 207 and a second outlet 208. The pump 206 includes a third inlet 209 and a third outlet 210. The third inlet 209 is connected to the second outlet 208 via the second pipeline 204. The third outlet 210 is connected to the second inlet 207 via the third pipeline 205. The first inlet 107 is connected in parallel to the second pipeline 204 or the third pipeline 205 via a fourth pipeline 211. The printhead 201 is removably mounted to the first outlet 108.

In addition, the ink supply system 200 can be provided with a second filter 212. In some embodiments, the second filter 212 is mounted in the second pipeline 204. In addition, the ink reservoir 100 is connected in parallel to the second pipeline 204 through the fourth pipeline 211, which is, the fourth pipeline 211 is connected in parallel to a portion of the second pipeline 204 at a rear end of the second filter 212.

In addition, in the ink supply system 200, the number of the ink reservoir 100 and the number of the printhead 201 are not particularly limited, which can be only one or a plurality.

The ink supply system 200 can improve the stability of ink supply to the printhead 201. Specifically, in the ink reservoir 100 of the ink supply system 200, the first cavity 104 and the second cavity 105 are provided in the main body 101, and the first valve 102 is configured to control the communication or blocking of the first cavity 104 and the second cavity 105, which can suppress the influence of the ink fluctuation in the main ink supply path 202 on the printhead 201, and can stabilize the ink supply to the printhead 201, thereby improving the stability of the ink supply of the printhead 201.

In addition, since the pump 206 is connected in series in the ink supply system 200, the pump 206 can be started as needed such that the main ink supply path 202 composed of the second pipeline 204 and the third pipeline 205 is always filled with ink, which is, the second pipeline 204 or the third pipeline 205 can be directly configured as an ink source for supplying ink to the ink reservoir 100, and a distance between the printhead 201 and the ink cartridge 203 can be shortened. Therefore, ink can be stably supplied to the printhead 201 via the ink reservoir 100, thereby improving the stability of ink supply to the printhead 201.

Furthermore, the ink reservoir 100 is connected in parallel to the second pipeline 204 or the third pipeline 205 as the main ink supply path 202 through the fourth pipeline 211, which is, the ink passes through the fourth pipeline 211 as a branch flow to enter the ink reservoir 100, such that a pressure of the ink can be suppressed from directly acting on the first valve 102, thereby suppressing the influence of the ink fluctuation in the main ink supply path 202 caused by the operation of the pump 206 on the ink reservoir 100, further improving the stability of the ink supply to the printhead 201.

In addition, the pump 206 in the embodiment is mainly configured to keep the main ink supply path 202 always filled with ink, rather than directly supplying ink to the printhead 201 (or the ink reservoir 100). Therefore, the pump 206 does not need to operate strictly in conjunction with the printing operation of the printhead 201, and can be started as needed. As a result, the ink in the main ink supply path 202 can be frequently transported, thereby suppressing the precipitation of the ink in the main ink supply path 202.

In the ink supply system 200, a type of the pump 206 is not particularly limited. In some embodiments, the pump can be a diaphragm pump or a peristaltic pump. In the ink supply system 200, the pump 206 is mainly configured to keep the main ink supply path 202 always filled with ink, rather than directly supplying ink to the printhead 201 (or the ink reservoir 100). Therefore, a micro diaphragm pump with greater stability is preferred.

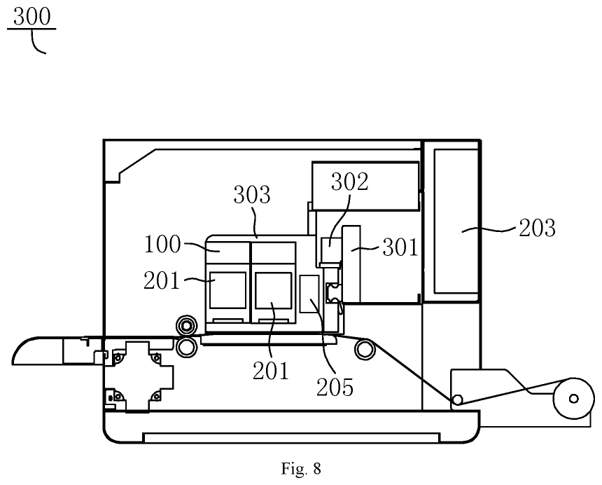

As shown in FIG. 8, the ink supply system 200 can be used in various printers. A type of the printer 300 is not particularly limited. In some embodiments, the printer can be an office printer, a home printer, etc. The printer 300 includes a manipulator 301 and the ink supply system 200. The manipulator 301 includes an end portion 302. The pump 206, the ink reservoir 100 and the printhead 201 are all mounted to the end portion 302.

The manipulator 301 is not particularly limited. In some embodiments, the manipulator 301 can be an existing single-axis manipulator configured to drive the printhead 201 back and forth. In some embodiments, the manipulator 301 is provided with a substrate 303 as the end portion 302. The pump 206, the ink reservoir 100 and the printhead 201 are mounted to the substrate 303.

According to the printer 300, the ink supply system 200 is provided, which can improve the stability of ink supply to the printhead 201. Furthermore, the pump 206 is mounted on the same substrate 303 as the ink reservoir 100 and the printhead 201, which can further shorten the distance between the ink reservoir 100 and the main ink supply path 202, and can reliably ensure that the main ink supply path 202 is always filled with ink, thereby further improving the stability of ink supply to the printhead 201.

Although the present disclosure has been described in detail above with reference to the embodiments, it should be understood that those of ordinary skill in the art can still make various changes, replacements and modifications to the features recited in the embodiments. It should be noted that those changes, replacements and modifications made without departing from the principles and purposes of the present disclosure shall fall within the scope of the disclosure defined by the appended claims.

What is claimed is:

1. An ink reservoir for a printhead, comprising:
a main body;
a first valve; and
a film;
wherein the main body comprises a first cavity, a second cavity, a first pipeline, a first inlet and a first outlet;
the first cavity is located at a first side of the main body;
the second cavity is located at a second side of the main body opposite to the first side of the main body;
the first cavity is communicated with the second cavity through the first pipeline;
the first inlet is communicated with the first cavity;
the first outlet is communicated with the second cavity, and is configured for mounting the printhead;
the first valve is arranged in the first pipeline, and comprises a piston and an elastic component; and the elastic component is configured to apply a first force to the piston in a direction from the first side of the main body toward the second side of the main body, such that the first pipeline is blocked by a first end of the piston; and
the film is provided at the second side for sealing the second cavity; a second end of the piston abuts against the film; and the film is configured to apply a second force to the piston in a direction from the second side of the main body toward the first side of the main body as a pressure in the second cavity decreases, so as to open the first pipeline.

2. The ink reservoir of claim 1, wherein a filter is provided in the first cavity.

3. The ink reservoir of claim 1, wherein the main body further comprises a barrier wall provided between the first cavity and the first pipeline; and the barrier wall is configured to reduce a cross-sectional area of a communicating opening between the first cavity and the first pipeline.

4. The ink reservoir of claim 3, wherein the first pipeline comprises a through channel and an extension channel;
the through channel is configured to penetrate through the main body along the direction from the first side of the main body toward the second side of the main body; and
a first end of the extension channel is communicated with the communicating opening between the first cavity and the first pipeline, and a second end of the extension channel is communicated with the through channel.

5. The ink reservoir of claim 4, wherein the first valve is arranged in the through channel; the elastic component abuts against the first end of the piston at the first side of the main body; and the second end of the piston passes through the through channel to enter the second cavity and abut against the film.

6. The ink reservoir of claim 1, wherein a reinforcing portion is provided at a middle of the film, and the second end of the piston abuts against the reinforcing portion.

7. The ink reservoir of claim 1, further comprising:
a second valve;
wherein the second valve is a one-way valve, and is arranged in the first outlet; and the second valve is configured to block the second cavity in a state that the first outlet is not connected to the printhead.

8. An ink supply system for a printer, comprising:
an ink cartridge;
a pump;
the ink reservoir of claim 1; and
a printhead;
wherein the ink cartridge comprises a second inlet and a second outlet;
the pump comprises a third inlet and a third outlet; the third inlet is communicated with the second outlet through a second pipeline; and the third outlet is communicated with the second inlet through a third pipeline;
the first inlet is connected in parallel to the second pipeline or the third pipeline through a fourth pipeline; and
the printhead is removably mounted to the first outlet.

9. The ink supply system of claim 8, wherein the pump is a diaphragm pump.

10. A printer, comprising:
a manipulator; and
the ink supply system of claim 8;
wherein the manipulator comprises an end portion; and
the pump, the ink reservoir and the printhead are mounted to the end portion.
